(19) United States
(12) Patent Application Publication
(10) Pub. No.: US 2025/0113343 A1
(43) Pub. Date: Apr. 3, 2025

(54) POSITIONING DATA DENSIFICATION

(71) Applicant: Nokia Technologies Oy, Espoo (FI)

(72) Inventors: Dick CARRILLO MELGAREJO, Espoo (FI); Oana-Elena BARBU, Aalborg (DK)

(21) Appl. No.: 18/899,420

(22) Filed: Sep. 27, 2024

(30) Foreign Application Priority Data
Sep. 29, 2023 (FI) 20236086

(51) Int. Cl. H04W 72/0453; H04W 24/10; H04W 72/51

(52) U.S. Cl. CPC H04W 72/0453; H04W 24/10; H04W 72/51

(57) ABSTRACT

Systems, methods, apparatuses, and computer program products for positioning data densification. A method may include transmitting a positioning frequency layer capability information to a network element. The method may also include receiving a positioning frequency layer aggregation configuration for data collection. The method may further include performing measurement collection from one or more positioning frequency layers based on the positioning frequency layer aggregation configuration. In addition, the method may include transmitting, to the network element, a report of collected measurements and their corresponding labels.

### FIELD

Some example embodiments may generally relate to mobile or wireless telecommunication systems, such as Long Term Evolution (LTE) or fifth generation (5G) new radio (NR) access technology, or 5G beyond, or sixth generation (6G) access technology, or other communications systems. For example, certain example embodiments may relate to positioning data densification.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, fifth generation (5G) radio access technology or new radio (NR) access technology and/or sixth generation (6G) radio access technology. Fifth generation (5G) and sixth generation (6G) wireless systems refer to the next generation (NG) of radio systems and network architecture. 5G and 6G network technology is mostly based on new radio (NR) technology, but the 5G/6G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include transmitting a positioning frequency layer capability information to a network element. The method may also include receiving a positioning frequency layer aggregation configuration for data collection. The method may further include performing measurement collection from one or more positioning frequency layers based on the positioning frequency layer aggregation configuration. In addition, the method may include transmitting, to the network element, a report of collected measurements and their corresponding labels.

Other example embodiments may be directed to an apparatus. The apparatus may include at least one processor and at least one memory storing instructions. The instructions, when executed by the at least one processor, cause the apparatus at least to transmit a positioning frequency layer capability information to a network element. The apparatus may also be caused to receive a positioning frequency layer aggregation configuration for data collection. The apparatus may further be caused to perform measurement collection from one or more positioning frequency layers based on the positioning frequency layer aggregation configuration. In addition, the apparatus may be caused to transmit, to the network element, a report of collected measurements and their corresponding labels.

Other example embodiments may be directed to an apparatus. The apparatus may include means for transmitting a positioning frequency layer capability information to a network element. The apparatus may also include means for receiving a positioning frequency layer aggregation configuration for data collection. The apparatus may further include means for performing measurement collection from one or more positioning frequency layers based on the positioning frequency layer aggregation configuration. In addition, the apparatus may include means for transmitting, to the network element, a report of collected measurements and their corresponding labels.

In accordance with other example embodiments, a non-transitory computer readable medium may be encoded with instructions that may, when executed in hardware, perform a method. The method may include transmitting a positioning frequency layer capability information to a network element. The method may also include receiving a positioning frequency layer aggregation configuration for data collection. The method may further include performing measurement collection from one or more positioning frequency layers based on the positioning frequency layer aggregation configuration. In addition, the method may include transmitting, to the network element, a report of collected measurements and their corresponding labels.

Other example embodiments may be directed to a computer program product that performs a method. The method may include transmitting a positioning frequency layer capability information to a network element. The method may also include receiving a positioning frequency layer aggregation configuration for data collection. The method may further include performing measurement collection from one or more positioning frequency layers based on the positioning frequency layer aggregation configuration. In addition, the method may include transmitting, to the network element, a report of collected measurements and their corresponding labels.

Other example embodiments may be directed to an apparatus that may include circuitry configured to transmit a positioning frequency layer capability information to a network element. The apparatus may also include circuitry configured to receive a positioning frequency layer aggregation configuration for data collection. The apparatus may further include circuitry configured to perform measurement collection from one or more positioning frequency layers based on the positioning frequency layer aggregation configuration. In addition, the apparatus may include circuitry configured to transmit, to the network element, a report of collected measurements and their corresponding labels.

Some example embodiments may be directed to a method. The method may include receiving a positioning frequency layer capability information from a user equipment. The method may also include configuring the user equipment with a positioning frequency layer aggregation configuration for data collection. The method may further include receiving, from the user equipment, a report of collected measurements and their corresponding labels based on the positioning frequency layer aggregation configuration.

Other example embodiments may be directed to an apparatus. The apparatus may include at least one processor and at least one memory storing instructions. The instructions, when executed by the at least one processor, cause the apparatus at least to receive a positioning frequency layer capability information from a user equipment. The apparatus may also be caused to configure the user equipment with a positioning frequency layer aggregation configuration for data collection. The apparatus may further be caused to receive, from the user equipment, a report of collected measurements and their corresponding labels based on the positioning frequency layer aggregation configuration.

Other example embodiments may be directed to an apparatus. The apparatus may include means for receiving a positioning frequency layer capability information from a user equipment. The apparatus may also include means for configuring the user equipment with a positioning frequency layer aggregation configuration for data collection. The apparatus may further include means for receiving, from the user equipment, a report of collected measurements and their corresponding labels based on the positioning frequency layer aggregation configuration.

In accordance with other example embodiments, a non-transitory computer readable medium may be encoded with instructions that may, when executed in hardware, perform a method. The method may include receiving a positioning frequency layer capability information from a user equipment. The method may also include configuring the user equipment with a positioning frequency layer aggregation configuration for data collection. The method may further include receiving, from the user equipment, a report of collected measurements and their corresponding labels based on the positioning frequency layer aggregation configuration.

Other example embodiments may be directed to a computer program product that performs a method. The method may include receiving a positioning frequency layer capability information from a user equipment. The method may also include configuring the user equipment with a positioning frequency layer aggregation configuration for data collection. The method may further include receiving, from the user equipment, a report of collected measurements and their corresponding labels based on the positioning frequency layer aggregation configuration.

Other example embodiments may be directed to an apparatus that may include circuitry configured to receive a positioning frequency layer capability information from a user equipment. The apparatus may also include circuitry configured to configure the user equipment with a positioning frequency layer aggregation configuration for data collection. The apparatus may further include circuitry configured to receive, from the user equipment, a report of collected measurements and their corresponding labels based on the positioning frequency layer aggregation configuration.

### BRIEF DESCRIPTION OF THE DRAWINGS

For proper understanding of example embodiments, reference should be made to the accompanying drawings, wherein:

FIG. 1 illustrates an example cumulative distribution function (CDF) performance of two datasets, according to certain example embodiments.

FIG. 2 illustrates an example signal diagram, according to certain example embodiments.

FIG. 3 illustrates an example flexible positioning frequency layer (PFL) aggregation, according to certain example embodiments.

FIG. 4 illustrates an example flow diagram of a method, according to certain example embodiments.

FIG. 5 illustrates an example flow diagram of another method, according to certain example embodiments.

FIG. 6 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for positioning data densification. For example, certain example embodiments may relate to artificial intelligence/machine learning (AIML) positioning data densification.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

In New Radio (NR) positioning, a positioning transmitter/receiver is needed to be capable of transmitting/receiving positioning signals on multiple aggregated positioning frequency layers (PFLs) or carriers. The PFL may be defined as a collection of positioning reference signal (PRS) resource sets with each PRS resource set defining as collection of PRS resources. The n-th PFL may include a PRS which occupies a variable bandwidth (BW). The BW may be an integer multiple of 4 physical resource blocks (PRBs), where the minimum BW is 4 PRBs and the maximum is 272 PRBs. The PRS may also occupy a variable number of symbols. For example, the PRS may be L_{PRS} orthogonal frequency division multiplexing (OFDM) symbols long, where L_{PRS} may take any value in the set of {2, 4, 6, 12}.

Furthermore, the PRS may occupy a variable number of subcarriers in each BW according to a combined setting. The comb K_{comb}^{PRS} can take any value in the set C={2, 4, 6, 12}, where comb K_{comb}^{PRS} signifies that every K_{comb}^{PRS}-th subcarrier contain a positioning sample. Throughout consecutive positioning sessions (e.g., a set of events or actions composed by generation of input data AIML model, and inference UE positions or intermediate feature), a positioning receiver may receive signals with a variable number of aggregated PFL, a variable BW per PFL, and a variable duration. In RANI, a location management function (LMF) may request the UE to report either a joint measurement for all PFLs, or a single measurement. The joint measurement may correspond to the aggregated BW, and may emulate an increase in the sampling resolution and, thus, increase the accuracy of the positioning measurements that the UE collects. The positioning measurements may contain timing, power and/or phase information of the channel response (channel impulse response (CIR), power delay profile (PDP), and/or delay profile (DP)). Additionally, the single measurement may correspond to the best measurement across multiple PFLs, and the PFL identification (ID) to which the measurement corresponds. However, there is currently no standard that supports the performance of a more flexible measurement reporting such as, for example, a partial combination of PFLs.

In AIML positioning, data collected from the UE may be sparse and lack diversity. AIML positioning may use a machine learning block such as, for example, based on fingerprinting, with input parameters based on physical layer measurements (CIR, PDP, DP), and the output may be the positioning estimation (direct AIML positioning) or intermediate feature estimation (AIML assisted positioning). Thus, it may be desirable to provide a way to densify the collected data and the PFL aggregation framework, and the joint and single measurements described above may offer an opportunity to accomplish this if properly executed to AIML positioning sub-use cases. Some examples of some positioning sub-use cases may include, but not limited to, for example: deploying the model in the UE-side for assisted and direct AIML, and the position is calculated in the UE-side; the model is deployed in the UE-side for AIML assisted, and the position is calculated in the LMF-side for downlink positioning; the model is deployed in the gNB-side for AIML assisted, and the position is calculated in the LMF; and the model is deployed in the LMF-side for direct AIML, and the position is calculated in the LMF for uplink positioning. Positioning accuracy enhancements for different scenarios may include, for example, those with heavy non-line-of-sight (NLOS) conditions, and AIML approaches for selected sub-use cases may need to be diverse enough to support various requirements on the gNB-UE collaboration levels. The AIML approaches may include, for example, schemes used for AIML positioning such as direct AIML positioning (interference is always the UE position), and AIML assisted positioning (interference is always an intermediate feature to be used by legacy or other AIML methodology).

According to certain example embodiments, in AIML positioning, the LMF may benefit from the UE reporting a joint measurement (e.g., measurements that include timing, power, and/or phase information of the channel response (CIR, PDP, DP)) for all PFLs, a joint measurement for subsets of PFLs, and/or an individual measurement per PFL. For example, when N PFLs are aggregated, the UE may collect L>N measurements by performing a joint measurement for all PFLs, a joint measurement subsets of PFLs, and/or an individual measurement per PFL. Here, L corresponds to the number of measurements collected by the UE. The UE may also label all the collected measurements with the same label (e.g., UE location, time difference of arrival (TDOA), etc.). In doing so, the LMF may obtain K>N>>1 measurements in one data acquisition snapshot instead of the standard single measurement per snapshot, where K is the maximum number of PFLs to be aggregated. Thus, according to certain example embodiments, it is possible to extend the current RAN agreements for PFL aggregation to support AIML data collection.

In certain example embodiments, the LMF may configure the UE with PFL aggregation for AIML data collection. The configuration may include a configuration that identifies the PFLs to be aggregated (e.g., PFL 1-K). The configuration may also identify the subsets of PFLs to be combined for each measurement sample. For example, the subsets may include a report of a joint measurement for PFL1 and 2, and/or PFL 2 and K, etc. The configuration may also identify a labeling source per PFL subset (e.g., label). For example, measurements obtained using the configuration for a subset of PFL1 and 2 may be labeled with a global navigation satellite system (GNSS) location, whereas measurements obtained using configuration for a subset of PFL2 and K may be labeled with a LOS indicator. In certain example embodiments, this field for labeling the source per PFL subset may be left empty if the data collection is for monitoring purposes instead of training. In other example embodiments, the configuration may identify the PRS time indices per PFL that should be combined (i.e., for how long the combination scheme applies).

In certain example embodiments, the UE may receive the configuration and perform the measurement collection from all the PFLs according to the scheme selected by the LMF. In some example embodiments, the UE may first check if the aggregation is possible at the time of application (e.g., the UE may check the coherence BW of the channel, and then apply the PFL aggregation if the aggregated PFLs are within the coherence BW). The UE may then report the collected measurements and their corresponding labels to the LMF. According to certain example embodiments, if a combination scheme is not applied, or the UE changes its mobility profile, the UE may flag the respective measurement as partly aggregated and indicate the dropped PFL(s) (e.g., PFL(s) that are discarded by the UE because of various reasons such as, for example, low signal to interference noise ratio (SINR)). According to some example embodiments, a combination scheme is not applied when one PFL layer is discarded by the UE (e.g., due to very low SINR).

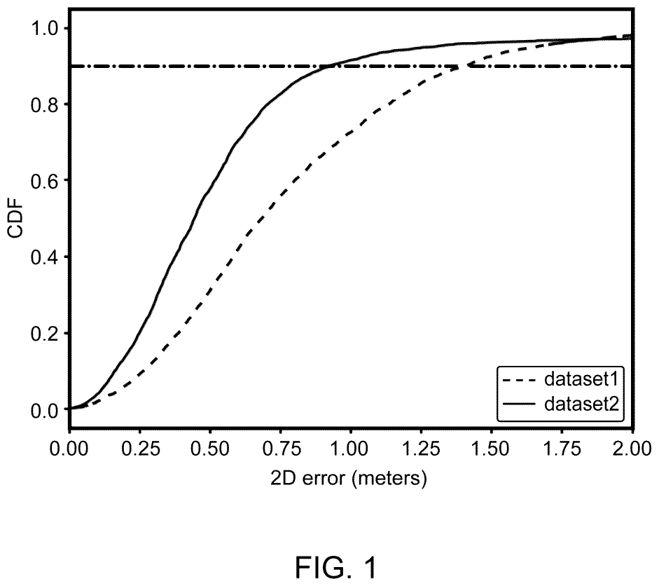

FIG. 1 illustrates an example cumulative distribution function (CDF) performance of two datasets, according to certain example embodiments. To show the impact of certain example embodiments, two datasets were generated by simulation. As illustrated in FIG. 1, dataset 1 may be generated with 1 measurement per ground truth, when 5 PFLs are aggregated together into one, which means that every UE label may have a unique DL measurement (channel impulse response (CIR)). Another dataset 2 may be generated with 5 measurements per ground truth. In the case of dataset 2, each measurement represents a CIR sample that was gathered by each subset of PFLs. Thus, in dataset 2, it is expected to have 5 different samples for the same ground truth.

As illustrated in FIG. 1, dataset 1 and dataset 2 are used to evaluate the model positioning performance of the same AIML model. The evaluation shows that the positioning performance on using dataset 2 outperforms dataset 1, with the positioning error being reduced by up to 40%. The reduction of positioning error may be attributed to having a variety of measurements for the same ground truth, which may provide an extra densification characteristic. The CDF of the performance on both datasets is illustrated in FIG. 1.

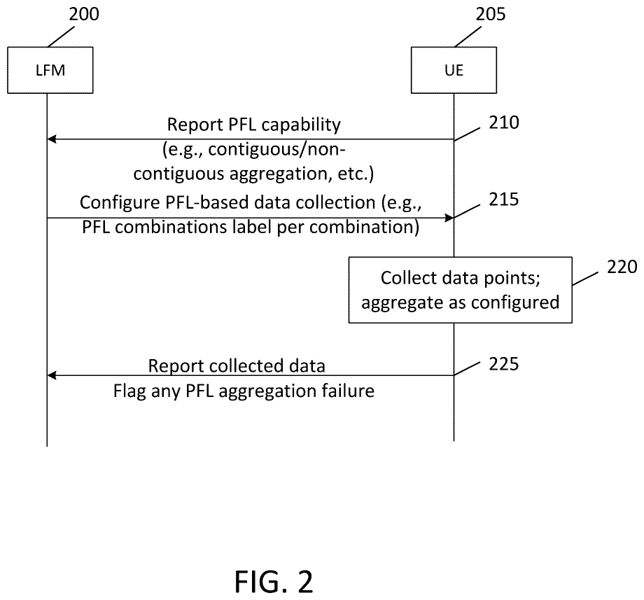

FIG. 2 illustrates an example signal diagram, according to certain example embodiments. At 210, the UE 205 provides the LMF 200 with a report of the UE's 205 PFL capability. In certain example embodiments, the PFL capability may include contiguous/non-contiguous aggregation of PFLs. According to certain example embodiments, contiguous PFLs aggregation may refer to carriers within the same operating frequency band. For non-contiguous allocation, it may either be intra-band (i.e., the operating frequency band, but have a gap in between), or it may be inter-band, in which case the component carriers belong to different operating frequency bands. At 215, the LMF 200 configures the UE with PFL aggregation for AIML data collection. According to certain example embodiments, the configuration message may be carried in LTE positioning protocol (LPP) assistance data as a new information element (IE), and may include at least the purpose of data collection (e.g., training, monitoring, other), an identification of a PFL to combine as a list (e.g., {pfl1, pfl2}(1), . . . , {pflx, pfly}(K)), labels per PFL combination (e.g., {GNSS location}(1), . . . , {LOS}(K)), and/or an identification of PRS indices to apply to the combination (e.g., {prs1, 2}(1), . . . , {prsA, C}(K)).

At 220, the UE 205 collects data points (e.g., corresponding to the measurements performed by the UE) and aggregates the data points as configured by the LMF 200. At 225, the UE reports the collected data. According to certain example embodiments, the report may be carried in a new IE in an LPP ProvideLocationInformation message, and the report may include at least the PFL index which has not been aggregated. The ProvideLocationInformation message may be a LPP message used by the target device to provide positioning measurements or position estimates to the location server. In other example embodiments, the report may optionally include the reason for failure (e.g., low-SINR). For instance, the report may include a flag identifying any PFL aggregation failure such as when a PFL layer is discarded by the UE, or when the UE changes its mobility profile. The flag may indicate that the respective measurement is partly aggregated, and indicate the dropped PFL(s).

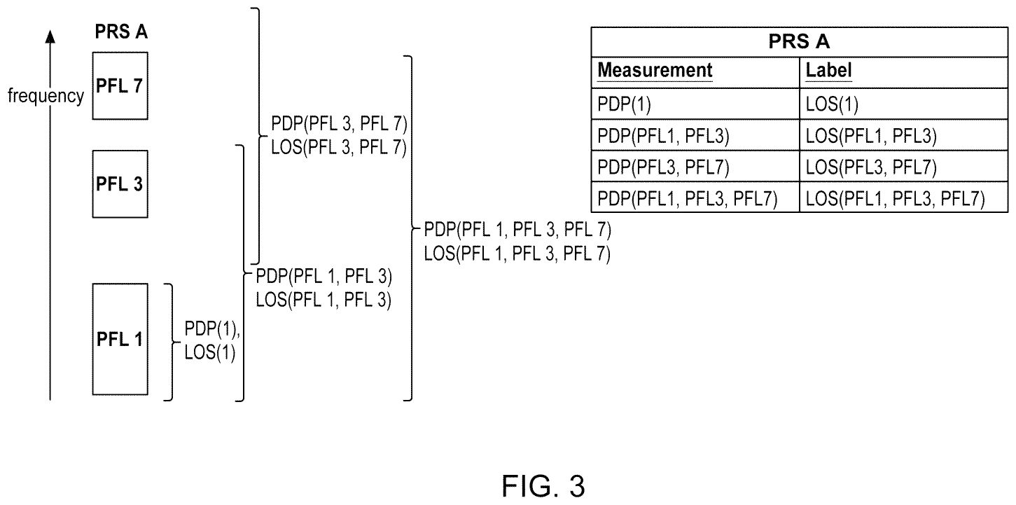

FIG. 3 illustrates an example flexible PFL aggregation, according to certain example embodiments. As illustrated in FIG. 3, 3 PFLs of a single PRS (called PRS A) are combined. In the example of FIG. 3, L=4 data samples (including labels) are collected by combining 1, 2, or 3 PFLs of the same PRS. FIG. 3 also illustrates an example of flexible PFL aggregation to obtain different measurements and labels. For example, one measurement/label may be obtained with PFL 1, whereas another measurement/label may be obtained with the aggregation of PFL 1 and PFL 3.

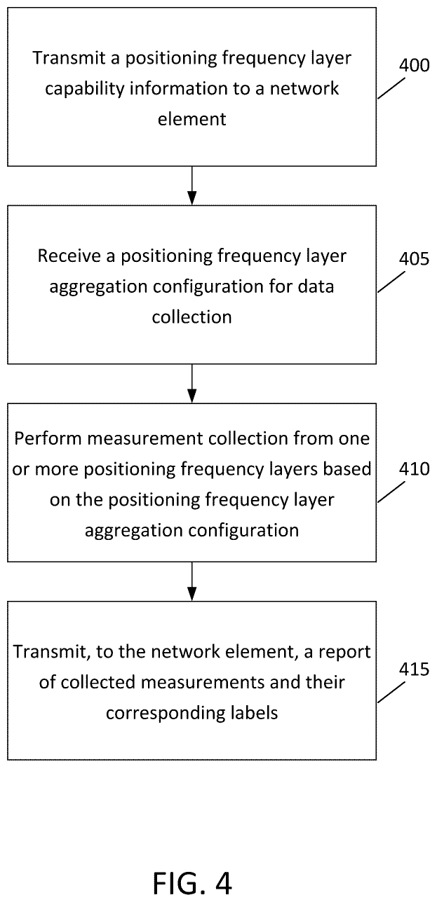

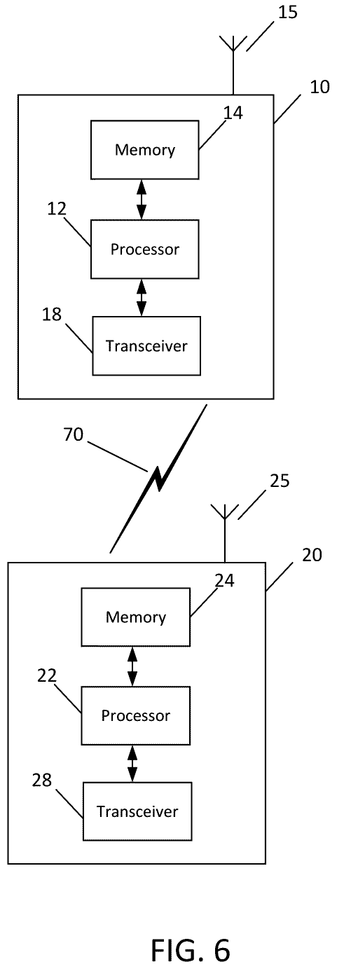

FIG. 4 illustrates an example flow diagram of a method, according to certain example embodiments. In an example embodiment, the method of FIG. 4 may be performed by a network entity, or a group of multiple network elements in a 3GPP system, such as LTE or 5G-NR. For instance, in an example embodiment, the method of FIG. 4 may be performed by a UE, similar to one of apparatuses 10 or 20 illustrated in FIG. 6.

As illustrated in FIG. 4, the method may include, at 400, transmitting a positioning frequency layer capability information to a network element. The method may also include, at 405, receiving a positioning frequency layer aggregation configuration for data collection. The method may further include, at 410, performing measurement collection from one or more positioning frequency layers based on the positioning frequency layer aggregation configuration. In addition, the method many include, at 415, transmitting, to the network element, a report of collected measurements and their corresponding labels.

According to certain example embodiments, the positioning frequency layer aggregation configuration may include at least one of an identification of positioning frequency layers to be aggregated, an identification of at least one subset of positioning frequency layers to be combined for each measurement sample of the collected measurements, labels per positioning frequency layer subset, or a duration of positioning frequency layer combination indicated in each corresponding positioning reference signal setting.

According to some example embodiments, the identification of the at least one subset of positioning frequency layers to be combined may include a command to report at least one of a joint measurement for all positioning reference layers, a joint measurement for subsets of positioning reference layers, or an individual measurement per positioning reference layer. According to other example embodiments, the labels may include at least one of a global navigation satellite system, or a line-of-sight indicator. According to further example embodiments, the method may also include flagging a respective measurement when a subset of the respective measurement is aggregated, and indicating a discarded positioning reference layer. In other example embodiments, the respective measurement may be flagged when one positioning frequency layer is discarded, or a mobility profile of a user equipment is changed.

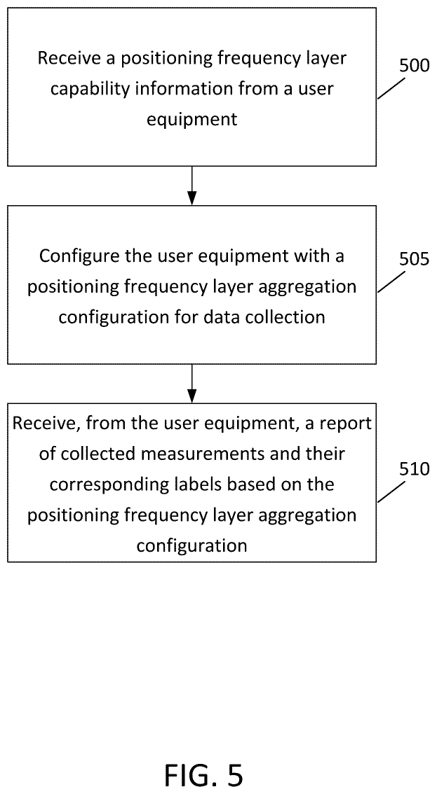

FIG. 5 illustrates an example flow diagram of a further method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a LMF or network, similar to one of apparatuses 10 or 20 illustrated in FIG. 6.

As illustrated in FIG. 5, the method may include, at 500, receiving a positioning frequency layer capability information from a user equipment. The method may also include, at 505, configuring the user equipment with a positioning frequency layer aggregation configuration for data collection. The method may further include, at 510, receiving, from the user equipment, a report of collected measurements and their corresponding labels based on the positioning frequency layer aggregation configuration.

According to certain example embodiments, the positioning frequency layer aggregation configuration may include at least one of an identification of positioning frequency layers to be aggregated, an identification of at least one subset of positioning frequency layers to be combined for each measurement sample of the collected measurements, labels per positioning frequency layer subset, or positioning reference signal time indices per positioning frequency layer that should be combined.

According to some example embodiments, the identification of the at least one subset of positioning frequency layers to be combined may include a command to report at least one of a joint measurement for all positioning reference layers, a joint measurement for subsets of positioning reference layers, or an individual measurement per positioning reference layer. According to other example embodiments, labels may include at least one of a global navigation satellite system, or a line-of-sight indicator. In other example embodiments, the report may include a flag identifying a respective measurement as partly aggregated, and identifying a dropped positioning reference layer.

FIG. 6 illustrates a set of apparatuses 10 and 20 according to certain example embodiments. In certain example embodiments, apparatuses 10 and 20 may be elements in a communications network or associated with such a network. For example, apparatus 10 may be a UE, or other similar radio communication computer device, and apparatus 20 may be a BS, gNB, LMF, network, or other similar computing device.

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 6.

As illustrated in the example of FIG. 6, apparatuses 10 and 20 may include or be coupled to a processor 12 and 22 for processing information and executing instructions or operations. Processors 12 and 22 may be any type of general or specific purpose processor. In fact, processors 12 and 22 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processor 12 and 22 is shown in FIG. 6, multiple processors may be utilized according to other example embodiments. For example, it should be understood that, in certain example embodiments, apparatuses 10 and 20 may include two or more processors that may form a multiprocessor system (e.g., in this case processors 12 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-5.

Apparatuses 10 and 20 may further include or be coupled to a memories 14 and 24 (internal or external), which may be respectively coupled to processors 12 and 24 for storing information and instructions that may be executed by processors 12 and 24. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-5.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 34 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to transmit a positioning frequency layer capability information to a network element. Apparatus 10 may also be controlled by memory 14 and processor 12 to receive a positioning frequency layer aggregation configuration for data collection. Apparatus 10 may further be controlled by memory 14 and processor 12 to perform measurement collection from one or more positioning frequency layers based on the positioning frequency layer aggregation configuration. In addition, apparatus 10 may be controlled by memory 14 and processor 12 to transmit, to the network element, a report of collected measurements and their corresponding labels.

In other example embodiments, apparatus 20 may be controlled by memory 24 and processor 22 to receive a positioning frequency layer capability information from a user equipment. Apparatus 20 may also be controlled by memory 24 and processor 22 to configure the user equipment with a positioning frequency layer aggregation configuration for data collection. Apparatus 20 may further be controlled by memory 24 and processor 22 to receive, from the user equipment, a report of collected measurements and their corresponding labels based on the positioning frequency layer aggregation configuration.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for transmitting a positioning frequency layer capability information to a network element. The apparatus may also include means for receiving a positioning frequency layer aggregation configuration for data collection. The apparatus may further include means for performing measurement collection from one or more positioning frequency layers based on the positioning frequency layer aggregation configuration. In addition, the apparatus may include means for transmitting, to the network element, a report of collected measurements and their corresponding labels.

Other example embodiments may be directed to an apparatus that includes means for performing any of the methods described herein including, for example, means for receiving a positioning frequency layer capability information from a user equipment. The apparatus may also include means for configuring the user equipment with a positioning frequency layer aggregation configuration for data collection. The apparatus may further include means for receiving, from the user equipment, a report of collected measurements and their corresponding labels based on the positioning frequency layer aggregation configuration.

Certain example embodiments described herein provide several technical improvements, enhancements, and/or advantages. For instance, in some example embodiments, it may be possible to perform a more flexible measurement reporting (e.g., partial combination of PFLs). It may also be possible to densify the collected data, and the PFL aggregation frameworks described herein may be extended to AIML positioning sub-use cases. In other example embodiments, it may be possible to densify the dataset and enhance the model training performance due to the addition of diversity in some cases to the same ground truth. Additionally, the densifying approach may have a consequence of a larger dataset size for training, which is reflected in significant improvements in the training model performance.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GCN 5G Core Network
5GS 5G System
BS Base Station
CIR Channel Impulse Response
DL Downlink
DP Delay Profile
eNB Enhanced Node B
E-UTRAN Evolved UTRAN
FOC Frequency Offset Correction
gNB 5G or Next Generation NodeB
LMF Location Management Function
LPP LTE Positioning Protocol
LTE Long Term Evolution
NR New Radio
PDP Power Delay Profile
PRS Positioning Reference Signal
PRU Positioning Reference Unit
RSRP Reference Signal Received Power
RSRPP Reference Signal Received Power Per Path
RSTD Reference Signal Time Difference
RTT Round Trip Time
SINR Signal to Interference Plus Noise Ratio
TDOA Time Difference of Arrival
TOA Time of Arrival
UE User Equipment
UL Uplink

We claim:

1. An apparatus, comprising:
at least one processor; and
at least one memory storing instructions, wherein the instructions, when executed by the at least one processor, cause the apparatus at least to
transmit a positioning frequency layer capability information to a network element;
receive a positioning frequency layer aggregation configuration for data collection;
perform measurement collection from one or more positioning frequency layers based on the positioning frequency layer aggregation configuration; and
transmit, to the network element, a report of collected measurements and their corresponding labels.

2. The apparatus according to claim 1, wherein the positioning frequency layer aggregation configuration comprises at least one of the following:
an identification of positioning frequency layers to be aggregated,
an identification of at least one subset of positioning frequency layers to be combined for each measurement sample of the collected measurements,
labels per positioning frequency layer subset, or
a duration of positioning frequency layer combination indicated in each corresponding positioning reference signal setting.

3. The apparatus according to claim 2, wherein the identification of the at least one subset of positioning frequency layers to be combined comprises a command to report at least one of the following:
a joint measurement for all positioning reference layers,
a joint measurement for subsets of positioning reference layers, or
an individual measurement per positioning reference layer.

4. The apparatus according to claim 1, wherein the labels comprise at least one of the following:
a user equipment location ground truth, or
a line-of-sight indicator.

5. The apparatus according to claim 1, wherein the instructions, when executed by the at least one processor, further cause the apparatus at least to:
flag a respective measurement when a subset of the respective measurement is aggregated; and
indicate a discarded positioning reference layer.

6. The apparatus according to claim 5, wherein the respective measurement is flagged when one positioning frequency layer is discarded, or a mobility profile of a user equipment is changed.

7. A method comprising:
transmitting a positioning frequency layer capability information to a network element;
receiving a positioning frequency layer aggregation configuration for data collection;
performing measurement collection from one or more positioning frequency layers based on the positioning frequency layer aggregation configuration; and
transmitting, to the network element, a report of collected measurements and their corresponding labels.

8. The method according to claim 7, wherein the positioning frequency layer aggregation configuration comprises at least one of the following:
an identification of positioning frequency layers to be aggregated,
an identification of at least one subset of positioning frequency layers to be combined for each measurement sample of the collected measurements,
labels per positioning frequency layer subset, or
a duration of positioning frequency layer combination indicated in each corresponding positioning reference signal setting.

9. The method according to claim 8, wherein the identification of the at least one subset of positioning frequency layers to be combined comprises a command to report at least one of the following:
a joint measurement for all positioning reference layers,
a joint measurement for subsets of positioning reference layers, or
an individual measurement per positioning reference layer.

10. The method according to claim 7, wherein the labels comprise at least one of the following:
a user equipment location ground truth, or
a line-of-sight indicator.

11. The method according to claim 7, further comprising:
flagging a respective measurement when a subset of the respective measurement is aggregated; and
indicating a discarded positioning reference layer.

12. The method according to claim 11, wherein the respective measurement is flagged when one positioning frequency layer is discarded, or a mobility profile of a user equipment is changed.

13. An apparatus, comprising:
at least one processor; and
at least one memory storing instructions, wherein the instructions, when executed by the at least one processor, cause the apparatus at least to
receive a positioning frequency layer capability information from a user equipment;
configure the user equipment with a positioning frequency layer aggregation configuration for data collection; and
receive, from the user equipment, a report of collected measurements and their corresponding labels based on the positioning frequency layer aggregation configuration.

14. The apparatus according to claim 13, wherein the positioning frequency layer aggregation configuration comprises at least one of the following:
an identification of positioning frequency layers to be aggregated,
an identification of at least one subset of positioning frequency layers to be combined for each measurement sample of the collected measurements,
labels per positioning frequency layer subset, or
positioning reference signal time indices per positioning frequency layer that should be combined.

15. The apparatus according to claim 14, wherein the identification of the at least one subset of positioning frequency layers to be combined comprises a command to report at least one of the following:
a joint measurement for all positioning reference layers,
a joint measurement for subsets of positioning reference layers, or
an individual measurement per positioning reference layer.

16. The apparatus according to claim 14, wherein the labels comprise at least one of the following:
a user equipment location ground truth, or
a line-of-sight indicator.

17. The apparatus according to claim 13, wherein the report comprises a flag identifying a respective measurement as partly aggregated, and identifying a discarded positioning reference layer.
